(19) United States
(12) Patent Application Publication
(10) Pub. No.: US 2009/0273111 A1
(43) Pub. Date: Nov. 5, 2009

(54) METHOD OF MAKING A WIND TURBINE ROTOR BLADE

(75) Inventor: Vishal Bansal, Overland Park, KS (US)

Correspondence Address: GE ENERGY GENERAL ELECTRIC;C/O ERNEST G. CUSICK, ONE RIVER ROAD, BLD. 43, ROOM 225, SCHENECTADY, NY, 12345, US

(73) Assignee: BHA Group, Inc.

(21) Appl. No.: 12/112,162

(22) Filed: Apr. 30, 2008

(51) Int. Cl. B29C 43/56

(52) U.S. Cl. 264/101

(57) ABSTRACT

A method of manufacturing an article with vacuum assist. The method comprises the steps of providing a work-piece to be impregnated with resin. The work-piece has reinforcing fibers. A microporous membrane is applied over the work-piece. The microporous membrane has an oleophobic treatment. A vacuum film is applied over the microporous membrane. A polymeric resin is introduced to the work-piece. The resin is infused through the work-piece by applying a vacuum to the work-piece. The resin is cured to form the article.

### BACKGROUND OF THE INVENTION

This invention relates generally to fabricating a fiber-reinforced article and particularly to fabricating a wind turbine rotor blade by vacuum assisted molding utilizing an oleophobic microporous membrane.

Relatively large articles made from fiber-reinforced resin matrix article are known. One such article is a wind turbine rotor blade. Considerable efforts are under way to develop wind turbine rotor blades that are reliable and efficient. Because of their size, wind turbine rotor blades can be difficult, expensive and time consuming to manufacture.

Known wind turbine rotor blades are fabricated by infusing resin into a fiber-reinforced layer disposed adjacent a core with vacuum. A layer of distribution mesh is used to feed resin into the core material during manufacture. Laminated sheet material is placed over/under the mesh. The laminated sheet material includes a microporous membrane. It is known that the resin can, at times, wet the membrane. This can render the membrane less effective. Therefore, a need exists for an improved membrane for use in vacuum assisted molding operations.

### BRIEF DESCRIPTION OF THE INVENTION

One aspect of the invention is a method of manufacturing an article with vacuum assist. The method comprises the steps of providing a work-piece to be impregnated with resin. The work-piece has reinforcing fibers. A microporous membrane is applied over the work-piece. The microporous membrane has an oleophobic treatment. A vacuum film is applied over the microporous membrane. A polymeric resin is introduced to the work-piece. The resin is infused through the work-piece by applying a vacuum to the work-piece. The resin is cured to form the article.

Another aspect of the invention is a method of manufacturing a wind turbine rotor blade. The method comprises the steps of providing a core. A reinforcing skin is applied to the core to form a blade subassembly. The reinforcing skin has reinforcing fibers. A microporous membrane is applied over the reinforcing skin. The microporous membrane has an oleophobic treatment. A vacuum film is applied over the microporous membrane. A polymeric resin is introduced to the core. The resin is infused through the core and through the reinforcing skin by applying a vacuum to the blade subassembly. The resin is cured to form the rotor blade.

Yet another aspect of the invention is a method of manufacturing an article with vacuum assist. The method comprises the steps of providing a work-piece to be impregnated with resin. The work-piece has reinforcing fibers. An expanded polytetrafluoroethylene microporous membrane is applied over the work-piece. The membrane has an oleophobic treatment and an oil resistance rating in the range of a number 4 to a number 7 determined by AATCC 118 testing. A vacuum film is applied over the membrane. A polymeric resin is introduced to the work-piece. The resin is infused through the work-piece by applying a vacuum to the work-piece.

### BRIEF DESCRIPTION OF THE DRAWINGS

These and other features, aspects, and advantages of the invention will be better understood when the following detailed description is read with reference to the accompanying drawings, in which:

FIG. 1 is a perspective view illustrating a wind turbine rotor blade made according to one aspect of the invention.

FIG. 2 is an exploded perspective view illustrating the manufacture of a portion of the wind turbine rotor blade shown in FIG. 1, according to one aspect of the invention;

FIG. 3 is a cross-sectional view of the components illustrated in FIG. 1; and

FIG. 4 is an enlarged cross-sectional view of a laminate layer illustrated in FIGS. 2 and 3.

### DETAILED DESCRIPTION OF THE INVENTION

A method of fabricating a fiber-reinforced resin matrix article, such as a wind turbine rotor blade, utilizing an oleophobic microporous membrane is described below in detail. The oleophobic microporous membrane resists the passage of resins to an extent that is heretofore unknown while permitting gas to pass through it. This permits a vacuum to be applied relatively evenly to the entire rotor blade and enable the use of resins at operating conditions that have relatively low surface tensions. The oleophobic microporous membrane also facilitates a controlled flow front and reduces defects that could result from uneven resin flow. Production cycle time along with labor time is reduced along with a reduction in the cost of process consumable materials. The use of the oleophobic microporous membrane provides improved blade quality, for example, lower void content, reduced manual rework and optimized reinforcing fiber to resin ratios.

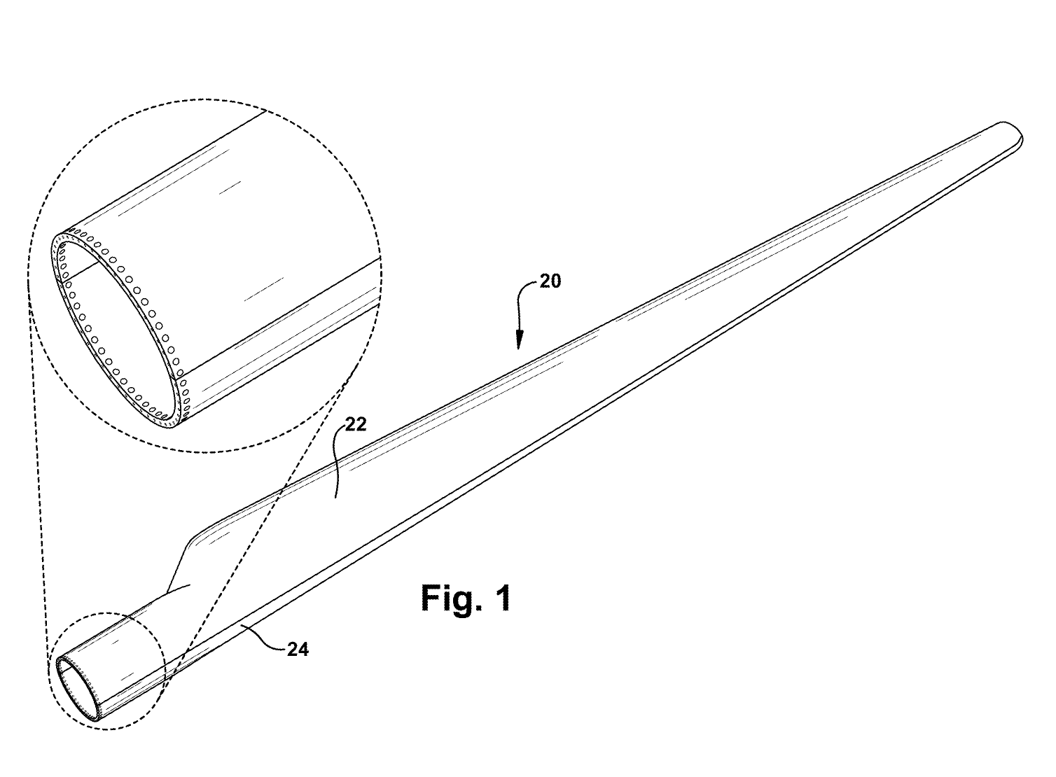

A wind turbine typically includes a plurality of relatively large rotor blades 20, one of which is illustrated in FIG. 1, coupled to a hub. Each blade 20 is positioned about the hub for rotation and transfer kinetic energy from the wind into usable energy. As the wind strikes the blade 20, it rotates about the axis of the hub and is subjected to centrifugal forces, various bending moments and forces due to the weight of the blade itself.

The blade 20 is made from a pair of blade halves or parts 22 and 24. The blade parts 22 and 24 are made separately. The blade parts 22 and 24 are then fixed together by suitable means to form the blade 20, as illustrated in FIG. 1.

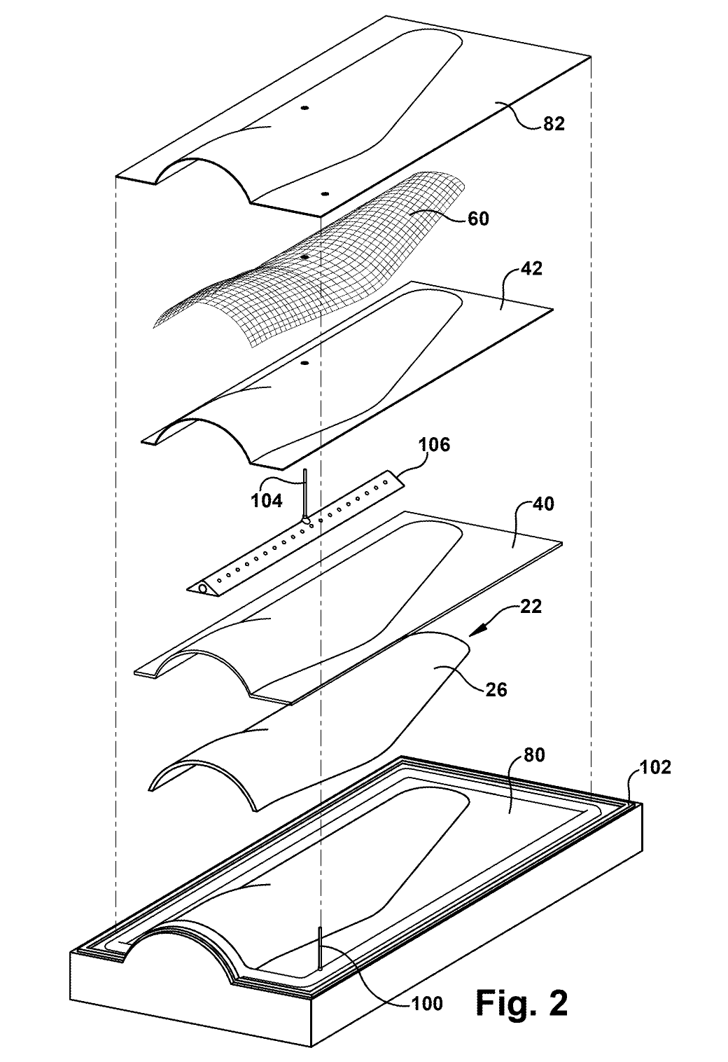

Referring to FIG. 2, each part 22 or 24 of the blade 20 includes a core (not shown) that is formed from a polymeric foam, wood, and/or a metal honeycomb. The core typically includes a plurality of grooves to facilitate the flow of resin through core during manufacture. Examples of suitable polymeric foams include, but are not limited to, PVC foams, polyolefin foams, epoxy foams, polyurethane foams, polyisocyanurate foams, and mixtures thereof.

The blade part 22 or 24 includes at least one layer of reinforcing skin 26 located adjacent the core to form a work-piece. Each reinforcing skin 26 is formed from a mat of reinforcing fibers. Typically, the mat is a woven mat of reinforcing fibers or a non-woven mat of reinforcing fibers. The mat of reinforcing fiber has voids throughout the reinforcing skin 26 that are to be completely filled with resin. Examples of suitable reinforcing fibers include, but are not limited to, glass fibers, graphite fibers, carbon fibers, polymeric fibers, ceramic fibers, aramid fibers, kenaf fibers, jute fibers, flax fibers, hemp fibers, cellulosic fibers, sisal fibers, coir fibers and mixtures thereof.

A resin is infused into the reinforcing skins 26 and cured. This provides integrity and strength to each part 22 and 24 of the blade 20. Examples of suitable resins include, but are not limited to, vinyl ester resins, epoxy resins, polyester resins, and mixtures thereof. The infused resin cures with heat and/or time in order to provide a solid part 22 or 24 for the blade 20.

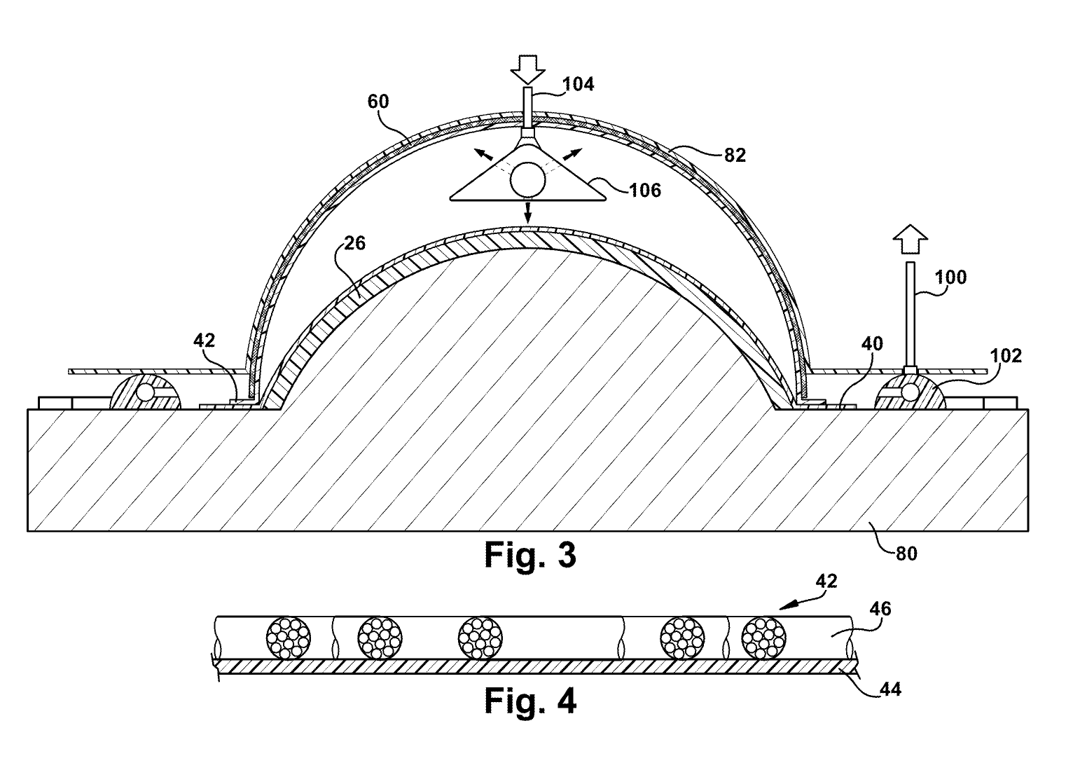

During manufacture of one part 22 (FIGS. 2 and 3) or 24 of the blade 20, the reinforcing skin 26 is wrapped around the core and then positioned in a mold 80. The manufacture of part 22 is described in detail below and it will be understood that the process is the same for part 24.

A release material 40 is applied to the outer surface of the reinforcing skin 26 of the part 22 or 24. The release material 40 in the form of a release film and peel ply. A membrane assembly 42 is then applied over the release material and the outer surface of blade 20 to facilitate the resin infusion process.

An air transporter material 60 is positioned over membrane assembly 42 to assist in degassing the work-piece by permitting air displaced during the infusion of resin to escape the voids in the reinforcing skin 26. Air transporter material 60 can be formed from any suitable mesh or fabric material, for example, a polyethylene mesh.

An impermeable vacuum bagging film or vacuum film 82 formed from a suitable material, for example, a polyamid, is positioned over air transporter material 60. A vacuum connection 100 extends through vacuum bagging film 82. A seal 102 extends around the periphery of the mold 80 between the mold and vacuum bagging film 82 to prevent leakage of air and resin. The seal 102 is in fluid connection with the vacuum connection 100.

A resin infusion input connection 104 extends trough the vacuum bagging film 82. The resin infusion connection 104 is in fluid connection with a resin supply tube 106 running essentially for the longitudinal extent of the mold 80. The resin supply tube 106 is positioned adjacent the outer reinforcing skin 26.

The resin is introduced into the resin infusion connection 104, the resin supply tube 106 and reinforcing skins 26 while a vacuum is established through vacuum connection 100. The vacuum facilitates resin flow and infuses the resin into core and reinforcing skin 26. Membrane assembly 42 prevents the resin from flowing away from reinforcing skins 26 while permitting air displaced by the infused resin to escape to the vacuum connection 100. The resin is then cured. Resin input connection 104 and supply tube 106, air transporter material 60, vacuum bagging film 82, membrane assembly 42 and release material 40 are removed from the blade part 22.

In one aspect of the invention, membrane assembly 42 (FIG. 4) includes a membrane 44 thermally or adhesively laminated to a backing material 46. The backing material 46 is formed from non-woven or woven polymeric fibers, for example, polyester fibers, nylon fibers, polyethylene fibers and mixtures thereof.

The membrane 44 is preferably a microporous polymeric membrane that allows the flow of gases, such as air or water vapor, into or through the membrane and is hydrophobic. A preferred microporous polymeric membrane for use as the membrane 26 includes expanded polytetrafluoroethylene (ePTFE) that has preferably been at least partially sintered. An ePTFE membrane typically comprises a plurality of nodes interconnected by fibrils to form a microporous lattice type of structure, as is known.

Membrane 44 has an average pore size of about 0.01 micrometer (μ) to about 10 μp. Membrane 44 is formed from any suitable material, for example, polytetrafluoroethylene, polyolefin, polyamide, polyester, polysulfone, polyether, acrylic and methacrylic polymers, polystyrene, polyurethane, polypropylene, polyethylene, polyphenelene sulfone, and mixtures thereof.

It was found that a membrane 44 could be coated with an oleophobic fluoropolymer material in such a way that enhanced oleophobic properties result without compromising its air permeability. Surfaces of the nodes and fibrils define numerous interconnecting pores that extend completely through the membrane 44 between the opposite major side surfaces of the membrane in a tortuous path. Typically, the porosity (i.e., the percentage of open space in the volume of the membrane 26) of the membrane 44 is between about 50% and about 98%. The oleophobic fluoropolymer coating adheres to the nodes and fibrils that define the pores in the membrane.

Substantially improved oleophobic properties of the microporous membrane 16 can be realized if the surfaces defining the pores in the membrane 44 and the major sides of the membrane are coated with an oleophobic fluoropolymer. The coating may be applied by any suitable means, such as those disclosed and described in U.S. Pat. No. 6,228,477 or U.S. Patent Application Publication 2004/0059717.

The use of an oleophobic fluoropolymer, such as an acrylic-based polymer with fluorocarbon side chains, to coat to the microporous membrane 44 reduces the surface energy of the membrane so fewer challenge materials are capable of wetting the composite membrane and enter the pores. The oleophobic fluoropolymer coating on the membrane 44 also increases the contact angle for a challenge material relative to the composite membrane. The increased oleophobic property of the membrane 44 is important as resins and hardeners that are used have relatively low surface tensions.

An exemplary oleophobic fluoropolymer for the coating is an acrylic-based polymer with fluorocarbon side. One family of acrylic-based polymer with fluorocarbon side chains that has shown particular suitability is the Zonyl® family of fluorine containing polymers (made by du Pont). A particularly suitable aqueous dispersion in the Zonyl® family is Zonyl® 7040.

Suitable polymeric materials for the porous backing material 46 include, for example, stretched or sintered plastics, such as polyesters, polypropylene, polyethylene, and polyamides (e.g., nylon). These materials are often available in various weights including, for example, 0.5 oz/yd² (about 17 gr/m²), 1 oz/yd² (about 34 gr/m²), and 2 oz/yd² (about 68 gr/m²). Woven fabric such as 70 denier nylon woven taffeta pure finish may also be used. Another suitable fabric is a non-woven textile such as a 1.8 oz/yd²co-polyester flat-bonded bi-component non-woven media.

The membrane assembly 42 is gas permeable and oleophobic. That is, the membrane assembly 42 permits the passage of gases through it. The addition of the oleophobic treatment increases the resistance of the membrane assembly 42 to being fouled by resin, oil or oily substances. The microporous membrane 44 of the membrane assembly 42 has an oil hold out or resistance rating in the range of a number 4 to a number 7 as determined by AATCC 118 testing. The microporous membrane 44 also has an air permeability of at least 0.01 CFM/ft² at 0.5″ water column as determined by ASTM D737 testing

While the invention has been described in terms of various specific embodiments, those skilled in the art will recognize that the invention extends beyond the specifically disclosed embodiments to other alternative embodiments and/or uses of the systems, techniques and obvious modifications and equivalents of those disclosed. It is intended that the scope of the invention disclosed should not be limited by the particular disclosed embodiments described above.

What is claimed is:

1. A method of manufacturing a wind turbine rotor blade, the method comprising the steps of:
providing a core;
applying a reinforcing skin to the core to form a blade subassembly, the reinforcing skin comprising reinforcing fibers;
applying a microporous membrane over the reinforcing skin, the microporous membrane having an oleophobic treatment;
applying a vacuum film over the microporous membrane;
introducing a polymeric resin to the core;
infusing the resin through the core and through the reinforcing skin by applying a vacuum to the blade subassembly; and
curing the resin to form the rotor blade.

2. The method of claim 1 wherein the microporous membrane is made from expanded polytetrafluoroethylene.

3. The method of claim 1 wherein the microporous membrane has an oil resistance rating in the range of a number 4 to a number 7 determined by AATCC 118 testing.

4. The method of claim 1 wherein the oleophobic treatment comprises a fluorinated acrylic polymer.

5. The method of claim 1 wherein the microporous membrane comprises a plurality of pores having an average diameter of about 0.01μ to about 10μ.

6. The method of claim 1 wherein the microporous membrane has a backing material on one surface.

7. The method of claim 1 further comprising applying an air transporter material layer between the vacuum film and the microporous membrane.

8. The method of claim 1 wherein the polymeric resin comprises at least one of vinyl ester resins and epoxy-based resins.

9. The method of claim 1 wherein the microporous membrane has an air permeability of at least 0.01 CFM/ft² as determined by ASTM D737 testing.

10. The method of claim 1 further including the step of positioning the blade subassembly in a mold having a desired shape.

11. A method of manufacturing an article with vacuum assist, the method comprising the steps of:
providing a work-piece to be impregnated with resin, the work-piece having reinforcing fibers;
applying a microporous membrane over the work-piece, the microporous membrane having an oleophobic treatment;
applying a vacuum film over the microporous membrane;
introducing a polymeric resin to the work-piece;
infusing the resin through the work-piece by applying a vacuum to the work-piece; and
curing the resin to form the article.

12. The method of claim 11 wherein the microporous membrane is made from expanded polytetrafluoroethylene.

13. The method of claim 11 wherein the microporous membrane has an oil resistance rating in the range of a number 4 to a number 7 determined by AATCC 118 testing.

14. The method of claim 11 wherein the oleophobic treatment comprises a fluorinated acrylic polymer.

15. The method of claim 11 wherein the microporous membrane comprises a plurality of pores having an average diameter of about 0.01μ to about 10μ.

16. The method of claim 11 wherein the microporous membrane has a backing material on one surface.

17. The method of claim 11 wherein the polymeric resin comprises at least one of vinyl ester resins and epoxy-based resins.

18. The method of claim 11 wherein the microporous membrane has an air permeability of at least 0.01 CFM/ft² as determined by ASTM D737 testing.

19. A method of manufacturing an article with vacuum assist, the method comprising the steps of:
providing a work-piece to be impregnated with resin, the work-piece having reinforcing fibers;
applying an expanded polytetrafluoroethylene microporous membrane over the work-piece, the membrane having an oleophobic treatment and an oil resistance rating in the range of a number 4 to a number 7 determined by AATCC 118 testing;
applying a vacuum film over the microporous membrane;
introducing a polymeric resin to the work-piece; and
infusing the resin through the work-piece by applying a vacuum to the work-piece.

20. The method of claim 19 wherein the membrane has an air permeability of at least 0.01 CFM/ft² as determined by ASTM D737 testing.
